(19) United States
(12) Patent Application Publication
(10) Pub. No.: US 2025/0062881 A1
(43) Pub. Date: Feb. 20, 2025

(54) LIMITED BUFFER RATE MATCHING CALCULATION

(71) Applicant: NOKIA TECHNOLOGIES OY, Espoo (FI)

(72) Inventors: Keeth Saliya Jayasinghe LADDU, Espoo (FI); Matha DEGHEL, Massy (FR)

(21) Appl. No.: 18/931,586

(22) Filed: Oct. 30, 2024

Related U.S. Application Data
(63) Continuation of application No. PCT/IB2024/051338, filed on Feb. 13, 2024.

(30) Foreign Application Priority Data
Feb. 14, 2023 (FI) 20235152

(51) Int. Cl. H04L 5/00; H04W 72/232

(52) U.S. Cl. CPC H04L 5/0092; H04W 72/232

(57) ABSTRACT

Embodiments of the present disclosure relate to devices, methods, apparatuses and computer readable storage media of limited buffer rate matching (LBRM) calculation for simultaneous multi-panel transmission. The method comprises: receiving, by a terminal device and from a network device, one or more maximum rank values for at least one BWP of one or more serving cells of the terminal device, wherein the one or more maximum rank values are associated with one or more PUSCH transmission schemes; determining, by the terminal device, based at least on the one or more maximum rank values, a maximum number of layers for LBRM; and determining, by the terminal device, a TBS for LBRM using the maximum number of layers.

### RELATED APPLICATION

This application is a Continuation of International Patent Application No. PCT/IB2024/051338 filed Feb. 13, 2024, and which from Finnish Patent Application No. 20235152, filed Feb. 14, 2023, the disclosures of which are hereby incorporated by reference in their entirety.

### FIELD

Embodiments of the present disclosure generally relate to the field of telecommunication and in particular to devices, methods, apparatuses and computer readable storage media of limited buffer rate matching (LBRM) calculation for simultaneous multi-panel transmission, especially for the simultaneous multi-panel physical uplink shared channel (PUSCH) transmission.

### BACKGROUND

Physical layer development has been discussed in 3rd Generation Partnership Project (3GPP) New Radio (NR). One of objectives of this discussion focus on facilitating simultaneous uplink transmission for multi-panel UEs (MP-UEs).

### SUMMARY

In general, example embodiments of the present disclosure provide a solution of LBRM calculation for simultaneous multi-panel transmission.

In a first aspect of the present disclosure, there is provided an apparatus. The apparatus comprises at least one processor; and at least one memory storing instructions that, when executed by the at least one processor, cause the apparatus at least to: receive, from a network device, one or more maximum rank values for at least one Bandwidth Part (BWP) of one or more serving cells of the apparatus, wherein the one or more maximum rank values are associated with one or more PUSCH transmission schemes; determine, based at least on the one or more maximum rank values, a maximum number of layers for LBRM and determine a transport block size (TBS) for LBRM using the maximum number of layers.

In a second aspect of the present disclosure, there is provided an apparatus. The apparatus comprises at least one processor; and at least one memory storing instructions that, when executed by the at least one processor, cause the apparatus at least to: transmit, to a terminal device, one or more maximum rank values for at least one BWP of one or more serving cells of the terminal device, wherein the one or more maximum rank values are associated with one or more PUSCH transmission schemes and to be used for the terminal device to determine a maximum number of layers for LBRM.

In a third aspect of the present disclosure, there is provided a method. The method comprises: receiving, by a terminal device and from a network device, one or more maximum rank values for at least one BWP of one or more serving cells of the terminal device, wherein the one or more maximum rank values are associated with one or more PUSCH transmission schemes; determining, by the terminal device, based at least on the one or more maximum rank values, a maximum number of layers for LBRM; and determining, by the terminal device, a TBS for LBRM using the maximum number of layers.

In a fourth aspect of the present disclosure, there is provided a method. The method comprises: transmitting, by a network device and to a terminal device, one or more maximum rank values for at least one BWP of one or more serving cells of the terminal device, wherein the one or more maximum rank values are associated with one or more PUSCH transmission schemes and to be used for the terminal device to determine a maximum number of layers for LBRM.

In a fifth aspect of the present disclosure, there is provided an apparatus. The apparatus comprises means for receiving, from a network device, one or more maximum rank values for at least one BWP of one or more serving cells of the apparatus, wherein the one or more maximum rank values are associated with one or more PUSCH transmission schemes; means for determining, based at least on the one or more maximum rank values, a maximum number of layers for LBRM; and means for determining a TBS for LBRM using the maximum number of layers.

In a sixth aspect of the present disclosure, there is provided an apparatus. The apparatus comprises means for transmitting, to a terminal device, one or more maximum rank values for at least one BWP of one or more serving cells of the terminal device, wherein the one or more maximum rank values are associated with one or more PUSCH transmission schemes and to be used for the terminal device to determine a maximum number of layers for LBRM.

In a seventh aspect of the present disclosure, there is provided a non-transitory computer readable medium. The non-transitory computer readable medium comprises program instructions that, when executed by an apparatus, cause the apparatus to perform at least: receiving, from a network device, one or more maximum rank values for at least one BWP of one or more serving cells of the apparatus, wherein the one or more maximum rank values are associated with one or more PUSCH transmission schemes; determining, based at least on the one or more maximum rank values, a maximum number of layers for LBRM; and determining a TBS for LBRM using the maximum number of layers.

In an eighth aspect of the present disclosure, there is provided a non-transitory computer readable medium. The non-transitory computer readable medium comprises program instructions that, when executed by an apparatus, cause the apparatus to perform at least: transmitting, to a terminal device, one or more maximum rank values for at least one BWP of one or more serving cells of the terminal device, wherein the one or more maximum rank values are associated with one or more PUSCH transmission schemes and to be used for the terminal device to determine a maximum number of layers for LBRM.

In a ninth aspect of the present disclosure, there is provided a computer program. The computer program comprises instructions which, when executed by an apparatus, cause the apparatus to perform at least the following: receiving, from a network device, one or more maximum rank values for at least one BWP of one or more serving cells of the apparatus, wherein the one or more maximum rank values are associated with one or more PUSCH transmission schemes; determining, based at least on the one or more maximum rank values, a maximum number of layers for LBRM; and determining a TBS for LBRM using the maximum number of layers.

In a tenth aspect of the present disclosure, there is provided a computer program. The computer program comprises instructions which, when executed by an apparatus, cause the apparatus to perform at least the following: transmitting, to a terminal device, one or more maximum rank values for at least one BWP of one or more serving cells of the terminal device, wherein the one or more maximum rank values are associated with one or more PUSCH transmission schemes and to be used for the terminal device to determine a maximum number of layers for LBRM.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating an example of process according to some example embodiments of the present disclosure;

FIG. 3 shows a flowchart of an example method of LBRM calculation for simultaneous multi-panel transmission according to some example embodiments of the present disclosure;

FIG. 4 shows a flowchart of an example method of LBRM calculation for simultaneous multi-panel transmission according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), an Enhanced Machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the terms “network device”, “radio network device” and/or “radio access network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, low earth orbit (RAN) split architecture includes a Centralized Unit (CU) and a Distributed Unit (DU). In some other example embodiments, part of the radio access network device or full of the radio access network device may embarked on an airborne or space-borne NTN vehicle.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “transmission reception point (TRP)” may refer to an antenna port or an antenna array (with one or more antenna elements) available to the network device located at a specific geographical location. For example, a network device may be coupled with multiple TRPs in different geographical locations to achieve better coverage. Alternatively, or in addition, multiple TRPs may be incorporated into a network device, or in other words, the network device may comprise the multiple TRPs. The term “TRP” may be also referred to as a cell, such as a macro-cell, a small cell, a pico-cell, a femto-cell, a remote radio head, a relay node, etc. It is to be understood that the term “TRP” may refer to a logical concept which may be physically implemented by various manner. For example, a TRP may refer to or correspond to a physical cell identity (PCI) or control resource set (CORESET) Pool Index (i.e., CORESETPoolIndex). In example embodiments of the present disclosure, the term “TRP” can be used interchangeably with the terms “PCI” or “CORESETPoolIndex”. Therefore, example embodiments described with respect to the TRPs can be applied to PCIs or CORESETPoolIndexes.

In some example embodiments of the present disclosure, a PCI may be associated with a TRP in any suitable manner. For example, the PCI associated with the TRP may represent the TRP or correspond to the TRP. For another example, the PCI associated with the TRP may be a PCI of a cell to which the TRP belongs, or a cell within which the TRP is located, or a cell associated with the TRP.

In some example embodiments of the present disclosure, a CORESETPoolIndex may be associated with a TRP in any suitable manner. For example, the CORESETPoolIndex associated with the TRP may be a CORESETPoolIndex of a control resource configured for the TRP.

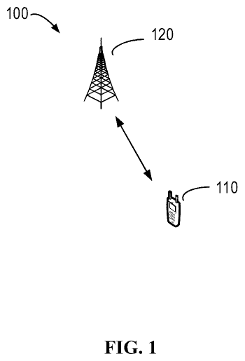

FIG. 1 shows an example communication network 100 in which embodiments of the present disclosure may be implemented. As shown in FIG. 1, the communication network 100 may include a terminal device 110. Hereinafter the terminal device 110 may also be referred to as a UE.

The communication network 100 may further include a network device 120. Hereinafter the network device 120 may also be referred to as a gNB. The terminal device 110 may communicate with the network device 120.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

For 3GPP NR physical layer development, how to facilitate simultaneous uplink transmission for MP-UEs has been discussed. The study of facilitating simultaneous multi-panel UL transmission for higher UL throughput/reliability may focus on frequency range 2 (FR2) and multi-TRP (mTRP).

Furthermore, some agreements are made to discuss different schemes for simultaneous transmission from multiple panels (STxMP). For example, for STxMP PUSCH in single-Downlink Control Information (DCI)-based mTRP system, study and evaluation may focus on the following schemes for PUSCH comprising the Space Division Multiplexing (SDM) scheme, wherein different layers/Demodulation Reference Signal (DMRS) ports of one PUSCH are separately precoded and transmitted from different UE panels simultaneously; and System Frame Number (SFN)-based transmission scheme, wherein all the same layers/DMRS ports of one PUSCH are transmitted from two different UE panels simultaneously.

For multi-DCI-based STxMP PUSCH plus PUSCH transmission, study and evaluate may focus on two PUSCHs are associated with different TRPs and transmitted from different UE panels and the total number of layers of these two PUSCHs is up to 4.

For dynamic switching between the SDM scheme of single-DCI-based STxMP PUSCH and single TRP (sTRP) transmission, the maximal number of layers for sTRP transmission is configured by a maximum rank or additional maximal numbers of layers for sTRP transmission and maximal number of layers of SDM transmission may be selected from one single maximal number of layers, a maximum rank applied for the first SRS resource set and the second resource set, separate maximal numbers of layers for the first SRS resource set and the second SRS resource set, or determined by the maximal number(s) of layers of sTRP and the UE capability reporting for SDM.

Now the maximum number of layers used for STxMP is under discussion, which may be used for a calculation of the LBRM. The LBRM was defined with a step of determining the maximum number of layers (X), mainly to calculate the maximum Transport block Size (TBS) used to derive the buffer size limitation.

The present disclosure proposed a mechanism about how to calculate LBRM when the UE supports STxMP transmission schemes. In this solution, the network device 120 transmit to the terminal device 110 one or more maximum rank values for at least one bandwidth part of one or more serving cells of the terminal device. The terminal device 110 determines a maximum number of layers for LBRM based on the one or more maximum rank values and determine the TBS for LBRM using the determined maximum number of layers.

Example embodiments of the present disclosure will be described in detail below with reference to the accompanying drawings.

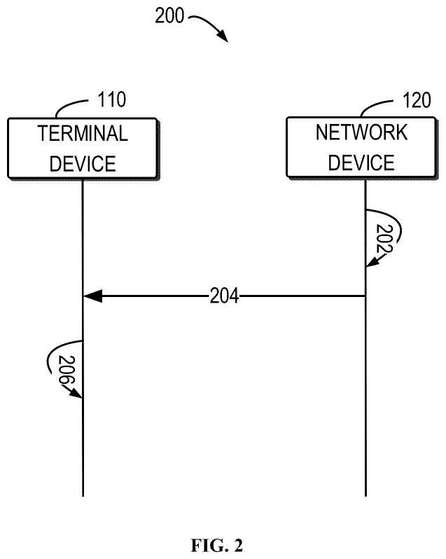

Reference is now made to FIG. 2, which shows a signaling chart 200 for communication according to some example embodiments of the present disclosure. As shown in FIG. 2, the signaling chart 200 involves the terminal device 110 and the network device 120. For the purpose of discussion, reference is made to FIG. 1 to describe the signaling chart 200.

In some scenarios, the terminal device 110 may be configured or indicated to support STxMP PUSCH transmission scheme. As shown in FIG. 2, the network device 120 may configure (202) one or more maximum rank values for at least one BWP of one or more serving cells of the terminal device 110 and transmit (204) the one or more maximum rank values to the terminal device 110.

In some example embodiments, the one or more maximum rank values for at least one BWP of one or more serving cells of the terminal device 110 may be configured in the PUSCH configuration.

The terminal device 110 then determines (206) a max number of layers for the LBRM calculation by considering the the one or more maximum rank values for at least one BWP of one or more serving cells of the terminal device 110 and one or more PUSCH transmission schemes.

In some example embodiments, the one or more PUSCH transmission schemes may refer to at least one of sTRP PUSCH transmission, S-DCI-based STxMP PUSCH transmission, and M-DCI-based STxMP PUSCH transmission.

In some example embodiments, the sTRP PUSCH transmission may refer further as S-DCI-based sTRP PUSCH transmission mode #1 and S-DCI-based sTRP PUSCH transmission mode #2. The S-DCI-based sTRP PUSCH transmission mode #1 may refer to sTRP PUSCH transmission when dynamic switching between sTRP PUSCH transmission and STxMP PUSCH transmission is not applied, while the S-DCI-based sTRP PUSCH transmission mode #2 may refer to sTRP PUSCH transmission when dynamic switching between sTRP PUSCH transmission and STxMP PUSCH transmission is applied.

In some example embodiments, the S-DCI-based STxMP PUSCH transmission may refer to multi-panel PUSCH transmission, often towards mTRP. Here, there may be more than one S-DCI-based STxMP PUSCH transmission mode, one mode being the SDM mode where different layers of the PUSCH are transmitted via different panels of the UE. Furthermore, the SFN mode may also be supported.

In some example embodiments, the M-DCI-based STxMP PUSCH transmission may refer to full-overlapping/partially-overlapping PUSCH transmissions via multiple panels, where PUSCH transmissions are independently scheduled by separate DCIs, often coming from different TRPs, which may be identified by CORESETPoolIndex or PCI.

More specifically, for determining the max number of layers for the LBRM calculation, the terminal device 110 may determine a maximum rank for the at least one BWP. Based on at least one maximum rank value of the one or more maximum rank values and/or at least one PUSCH transmission scheme of the one or more PUSCH transmission schemes, the maximum rank for the at least one BWP may be determined by the terminal device 110.

In some example embodiments, in addition to a first maximum rank value, if a second maximum rank value is defined/configured for the single TRP PUSCH transmission mode #2, i.e., the first and the second maximum rank values are configured in the PUSCH configuration for at least one BWP of the serving cell, the terminal device 110 may determine the maximum rank for the at least one BWP of the serving cell as a maximum value among the first maximum rank value and the second maximum rank value, which may be represented as: “max (first max Rank, second max Rank)”.

If the second maximum rank value is defined/configured for the S-DCI-based STxMP PUSCH transmission, the second maximum rank value may be associated with one or both Sounding Reference Signal (SRS) resource sets (e.g., first, second, or both SRS resource sets), the terminal device 110 may determine the maximum rank for the at least one BWP of the serving cell as a sum of the first maximum rank value and the second maximum rank value if the first maximum rank value is for a first SRS resource set and the second maximum rank value is for a second SRS resource set, which may be represented as: “first max Rank +second max Rank”.

If the second maximum rank value is defined/configured for the S-DCI-based STxMP PUSCH transmission, the second maximum rank value may be associated with one or both SRS resource sets (e.g., first, second, or both SRS resource sets), the terminal device 110 may determine the maximum rank for the at least one BWP of the serving cell as a maximum value among the first maximum rank value and the second maximum rank value multiplied by 2 if the first maximum rank value is applied for sTRP transmission and the second maximum rank value is applied for both the first and second SRS resource sets, which may be represented as: “max (first maximum rank, 2*second maximum rank)”.

Similarly, if the first maximum rank value is defined/configured for the S-DCI-based STxMP PUSCH transmission and the second maximum rank value is defined for the sTRP transmission, the first maximum rank value may be associated with one or both SRS resource sets (e.g., first, second, or both SRS resource sets), the terminal device 110 may determine the maximum rank for the at least one BWP of the serving cell as a maximum value among the second maximum rank value and the first maximum rank value multiplied by 2 if the second maximum rank value is applied for sTRP transmission and the first maximum rank value is applied for both the first and second SRS resource sets, which may be represented as: “max (2*first maximum rank, second maximum rank)”.

Alternatively, if the second maximum rank value is defined/configured for the M-DCI-based STxMP PUSCH transmission, the second maximum rank value may be associated with one or both CORESETPoolIndexes/PCIs (e.g., 0 or 1/PCIx or PCIy), the terminal device 110 may determine the maximum rank for the at least one BWP of the serving cell as a sum of the first maximum rank value and the second maximum rank value if the first maximum rank value is for the CORESETPoolIndex=0 (or PCIx) and the second maximum rank value is for the CORESETPoolIndex=1 (or PCIy), which may be represented as: first max Rank+second max Rank”.

If the second maximum rank value is defined/configured for the M-DCI-based STxMP PUSCH transmission, the second maximum rank value may be associated with one or both CORESETPoolIndexes/PCIs (e.g., 0 or 1/PCIx or PCIy), the terminal device 110 may determine the maximum rank for the at least one BWP of the serving cell as a maximum value among the first maximum rank value and the second maximum rank value multiplied by 2 if the first maximum rank value is for sTRP operation or M-DCI-based non-overlapping PUSCH transmission and the second maximum rank value is for the CORESETPoolIndex=0 or 1 (PCIx or PCIy), which may be represented as: “max (first maximum rank, 2*second maximum rank)”.

Similarly, if the second maximum rank value is defined/configured for the M-DCI-based STxMP PUSCH transmission, the first maximum rank value may be associated with one or both CORESETPoolIndexes/PCIs (e.g., 0 or 1/PCIx or PCIy), the terminal device 110 may determine the maximum rank for the at least one BWP of the serving cell as a maximum value among the second maximum rank value and the first maximum rank value multiplied by 2 if the second maximum rank value is for sTRP operation or M-DCI-based non-overlapping PUSCH transmission and the first maximum rank value is for the CORESETPoolIndex=0 or 1 (PCIx or PCIy), which may be represented as: “max (2*first maximum rank, second maximum rank)”.

In some example embodiments, in addition to a first maximum rank value, if two other maximum rank values, i.e., a second maximum rank value and a third maximum rank value are defined/configured for the sTRP PUSCH transmission mode #2 and/or S-DCI-based STxMP PUSCH transmission, respectively, the first, the second and the third maximum rank values may be associated with one or both SRS resource sets (e.g., first, second, or both SRS resource sets), the terminal device 110 may determine the maximum rank for the at least one BWP of the serving cell as a maximum value among the first maximum rank value and a sum of the second maximum rank value and the third maximum rank value, if the second maximum rank value is for a first SRS resource set and the third maximum rank value is for a second SRS resource set, which may be represented as: “max (first max Rank, second max Rank +third max Rank)”.

In this case, if the first maximum rank value is for a first SRS resource set and the third maximum rank value is for a second SRS resource set, the terminal device 110 may determine the maximum rank for the at least one BWP of the serving cell as a maximum value among the second maximum rank value and a sum of the first maximum rank value and the third maximum rank value, which may be represented as: “max (second max Rank, primary +third max Rank)”.

Still in this case, if the third maximum rank value is for both the first SRS resource set and second SRS resource set and the second maximum rank value is for the sTRP PUSCH transmission mode #2, the terminal device 110 may determine the maximum rank for the at least one BWP of the serving cell as a maximum value among the first maximum rank value, the second maximum rank value and the third maximum rank value multiplied by 2, which may be represented as: “max (first max Rank, second max Rank, 2*third max Rank)”.

In some example embodiments, in addition to a first maximum rank value, if two other maximum rank values, i.e., a second maximum rank value and a third maximum rank value are defined/configured for the M-DCI-based STxMP PUSCH transmission, the second and third maximum rank values may be associated with different CORESETPoolIndexes/PCIs (e.g., 0 or 1/PCIx or PCIy), the terminal device 110 may determine the maximum rank for the at least one BWP of the serving cell as a maximum value among the first maximum rank value, the second maximum rank value and the third maximum rank value, if the second maximum rank value is for the CORESETPoolIndex=0 (or PCIx) and the third maximum rank value is for the CORESETPoolIndex=1 (or PCIy), which may be represented as: “max (first max Rank, second max Rank+third max Rank)”.

In some example embodiments, if only a first maximum rank value is configured for at least one BWP of the serving cell and the first maximum rank value is associated with one or both SRS resource sets (e.g., first, second, or both SRS resource sets), the terminal device 110 may determine the maximum rank for the at least one BWP of the serving cell as the first maximum rank value multiplied by 2 when the first maximum rank value is applied for both first and second SRS resource sets, which may be represented as: “2*first max Rank”.

In this case, if the first maximum rank value is associated with one or both CORESETPoolIndexes/PCIs (e.g., 0 or 1), the terminal device 110 may determine the maximum rank for the at least one BWP of the serving cell as the first maximum rank value multiplied by 2 when the first maximum rank value is for the CORESETPoolIndex=0 or 1.

In this solution, different BWPs and serving cells may also be considered for different cases (some BWPs could support s-DCI while others STRP or M-DCI) mentioned above. For example, the terminal device 110 may determine the max number of layers for the LBRM calculation considering the maximum number of layers of PUSCH configuration across all BWP of the serving cell (or across all BWP of all serving cells).

Furthermore, the both M-DCI-based or S-DCI-based STxMP PUSCH transmission, the above cases may also be applied per TRP (e.g., CORESETPoolIndex, SRS resource set, PCI) level (instead of the per BWP assumption above).

In some example embodiments, when the per TRP LBRM calculations are applied (the use case may be due to UL rate matching buffer limitations at each TRP), separate maximum rank values (e.g., the first and second rank values) may be configured to the terminal device 110 where the first rank value may be applicable for the first TRP (e.g., CORESETPoolIndex=0 or PCIx) and the second rank value may be applicable for the second TRP (e.g., CORESETPoolIndex=1 or PCIy). In this case, the terminal device 110 may determine the max number of layers (and calculate LBRM separately) for each TRP (CORESETPoolIndex/PCI) across all BWP of the serving cell or across all BWP of all serving cells.

Based on the solution described in the present disclosure, one example of the impaction of the Specification may be listed as below:

In a case where one additional maximum rank value is configured, i.e., the one or more maximum rank values comprise a first and second maximum rank value,

```
                                  . . .
5.4.2.1 Bit selection
The bit sequence after encoding d₀, d₁, d₂, . . . , d_{N-1} from Clause 5.3.2 is written into
a circular buffer of length N_{cb} for the r -th coded block, where N is defined in Clause
5.3.2.
For the r -th code block, let N_{cb} = N if I_{LBRM} = 0 and N_{cb} = min(N, N_{ref})
$otherwise , where {N}_{ref} = ⌊ \frac{T B {S}_{L B R M}}{C \cdot {R}_{L B R M}} ⌋ , {R}_{LBRM} = 2 / 3 , {TBS}_{LBRM} is determined according$
to Clause 6.1.4.2 in [6, TS 38.214] for UL-SCH and Clause 5.1.3.2 in [6, TS 38.214]
for DL-SCH/PCH, assuming the following:
For one TB for DL-SCH with PDSCH scheduled by DCI format 4_0/4_1/4_2,
  - if the PDSCH is scheduled by DCI format 4_1/4_2,
    - maximum number of layers is given by X, where
      - if the higher layer parameter maxMIMO-Layers of pdsch-ConfigMulticast is
      configured, X is given by that parameter;
      - otherwise, X equals to 1;
    - if the higher layer parameter mcs-Table given by a pdsch-ConfigMulticast for at least
    one common frequency resource (CFR) is set to ′qam256′, maximum modulation order
    Qₘ = 8 is assumed for DL-SCH; otherwise a maximum modulation order Qₘ = 6 is
    assumed for DL-SCH;
  - if the PDSCH is scheduled by DCI format 4_0,
    - maximum number of layers is 1;
    - if the higher layer parameter mcs-Table given by a pdsch-ConfigMCCH is set to
    ′qam256′, maximum modulation order Qₘ = 8 is assumed for DL-SCH; otherwise a
    maximum modulation order Qₘ = 6 is assumed for DL-SCH;
    - if the higher layer parameter mcs-Table given by a pdsch-ConfigMTCH is set to
    ′qam256′, maximum modulation order Qₘ = 8 is assumed for DL-SCH; otherwise a
    maximum modulation order Qₘ = 6 is assumed for DL-SCH;
  - n_{PRB} = n_{PRB,LBRM} is given by Table 5.4.2.1-1, where the value of n_{PRB,LBRM} for DL-SCH
  is determined according to the size of the CFR if only one CFR is configured to the UE;
  - maximum coding rate of 948/1024;
  $- {N}_{R E} = 156 \cdot {n}_{P R B} ;$
  - C is the number of code blocks of the transport block determined according to Clause 5.2.2.
For one TB for UL-SCH, or for one TB for DL-SCH/PCH except for DL-SCH with
PDSCH scheduled by DCI format 4_0/4_1/4_2,
  - maximum number of layers for one TB for UL-SCH is given by X, where
    - if the higher layer parameter maxMIMO-Layers of PUSCH-ServingCellConfig of the
    serving cell is configured, X is given by that parameter
    - elseif
      when the TranmissionScheme of pusch-Config is set to ‘SDMscheme’ and the higher
      layer parameters maxRank and maxRank2 of pusch-Config of the serving cell are
      configured, the maximum rank L is the maximum value of maxRank and maxRank2 for
      the BWP, and X is given by the maximum value of the maximum rank L across all
      BWPs of the serving cell.
      when the TranmissionScheme of pusch-Config is set to mDCI-STxMP and the higher
      layer parameters maxRank and maxRank2 of pusch-Config of the serving cell are
      configured, the maximum rank L is the maximum value of maxRank and 2*maxRank2
      for the BWP, and X is given by the maximum value of the maximum rank L across all
      BWPs of the serving cell.
      otherwise, the higher layer parameter maxRank of pusch-Config of the serving cell is
      configured, X is given by the maximum value of maxRank across all BWPs of the
      serving cell
    - otherwise, X is given by the maximum number of layers for PUSCH supported by the
    UE for the serving cell
  - maximum number of layers for one TB for DL-SCH/PCH is given by the minimum of X
  and 4, where
    - if the higher layer parameter maxMIMO-Layers of PDSCH-ServingCellConfig of the
    serving cell is configured, X is given by that parameter
    - otherwise, X is given by the maximum number of layers for PDSCH supported by the
      UE for the serving cell
In a case where two additional maximum rank values are configured, i.e., the
one or more maximum rank values comprises a first and a second and a third
maximum rank values,
5.4.2.1 Bit selection
The bit sequence after encoding d₀, d₁, d₂, . . . , d_{N-1} from Clause 5.3.2 is written into
a circular buffer of length Nep for the r -th coded block, where N is defined in Clause
5.3.2.
For the r -th code block, let N_{cb} = N if I_{LBRM} = 0 and N_{cb} = min(N, N_{ref})
$otherwise , where {N}_{ref} = ⌊ \frac{T B {S}_{L B R M}}{C \cdot {R}_{L B R M}} ⌋ , {R}_{LBRM} = 2 / 3 , {TBS}_{LBRM} is determined according$
to Clause 6.1.4.2 in [6, TS 38.214] for UL-SCH and Clause 5.1.3.2 in [6, TS 38.214]
for DL-SCH/PCH, assuming the following:
For one TB for DL-SCH with PDSCH scheduled by DCI format 4_0/4_1/4_2,
  - if the PDSCH is scheduled by DCI format 4_1/4_2,
    - maximum number of layers is given by X, where
      - if the higher layer parameter maxMIMO-Layers of pdsch-ConfigMulticast is
      configured, X is given by that parameter;
      - otherwise, X equals to 1;
    - if the higher layer parameter mcs-Table given by a pdsch-ConfigMulticast for at least
    one common frequency resource (CFR) is set to ′qam256′, maximum modulation order
    Qₘ = 8 is assumed for DL-SCH; otherwise a maximum modulation order Qₘ = 6 is
    assumed for DL-SCH;
  - if the PDSCH is scheduled by DCI format 4_0,
    - maximum number of layers is 1;
    - if the higher layer parameter mcs-Table given by a pdsch-ConfigMCCH is set to
    ′qam256′, maximum modulation order Qₘ = 8 is assumed for DL-SCH; otherwise a
    maximum modulation order Qₘ = 6 is assumed for DL-SCH;
    - if the higher layer parameter mcs-Table given by a pdsch-ConfigMTCH is set to
    ′qam256′, maximum modulation order Qₘ = 8 is assumed for DL-SCH; otherwise a
    maximum modulation order Qₘ = 6 is assumed for DL-SCH;
  - n_{PRB} = n_{PRB,LBRM} is given by Table 5.4.2.1-1, where the value of n_{PRB,LBRM} for DL-SCH
  is determined according to the size of the CFR if only one CFR is configured to the UE;
  - maximum coding rate of 948/1024;
  $- {N}_{R E} = 156 \cdot {n}_{P R B} ;$
  - C is the number of code blocks of the transport block determined according to Clause 5.2.2.
For one TB for UL-SCH, or for one TB for DL-SCH/PCH except for DL-SCH with
PDSCH scheduled by DCI format 4_0/4_1/4_2,
  - maximum number of layers for one TB for UL-SCH is given by X, where
    - if the higher layer parameter maxMIMO-Layers of PUSCH-ServingCellConfig of the
    serving cell is configured, X is given by that parameter
    - elseif
      when the TranmissionScheme of pusch-Config is set to ‘SDMscheme’ and the higher
      layer parameters maxRank, maxRank2, and maxRank3 of pusch-Config of the serving
      cell are configured, the maximum rank L is the maximum value of maxRank, maxRank2,
      and 2*maxRank3 for the BWP, and X is given by the maximum value of the maximum
      rank L across all BWPs of the serving cell
      when the TranmissionScheme of pusch-Config is set to mDCI-STxMP and the higher
      layer parameters maxRank, maxRank2, and maxRank3 of pusch-Config of the serving
      cell are configured, the maximum rank L is the maximum value of maxRank and
      (maxRank2 + maxRank3) for the BWP, and X is given by the maximum value of the
      maximum rank L across all BWPs of the serving cell
      otherwise, the higher layer parameter maxRank of pusch-Config of the serving cell is
      configured, X is given by the maximum value of maxRank across all BWPs of the
      serving cell
    - otherwise, X is given by the maximum number of layers for PUSCH supported by the
    UE for the serving cell
  - maximum number of layers for one TB for DL-SCH/PCH is given by the minimum of X
  and 4, where
    - if the higher layer parameter maxMIMO-Layers of PDSCH-ServingCellConfig of the
    serving cell is configured, X is given by that parameter
    - otherwise, X is given by the maximum number of layers for PDSCH supported by the
    UE for the serving cell
In a case where only a first maximum rank value is configured, i.e., the one or more
maximum rank values comprises only the first maximum rank value,
  5.4.2.1 Bit selection
  The bit sequence after encoding d₀, d₁, d₂, . . . , d_{N-1} from Clause 5.3.2 is written into
  a circular buffer of length N_{cb} for the r -th coded block, where N is defined in Clause
  5.3.2.
  For the r -th code block, let N_{cb} = N if I_{LBRM} = 0 and N_{cb} = min(N, N_{ref})
  $otherwise , where {N}_{ref} = ⌊ \frac{T B {S}_{L B R M}}{C \cdot {R}_{L B R M}} ⌋ , {R}_{LBRM} = 2 / 3 , {TBS}_{LBRM} is determined according$
  to Clause 6.1.4.2 in [6, TS 38.214] for UL-SCH and Clause 5.1.3.2 in [6, TS 38.214]
  for DL-SCH/PCH, assuming the following:
  For one TB for DL-SCH with PDSCH scheduled by DCI format 4_0/4_1/4_2,
    - if the PDSCH is scheduled by DCI format 4_1/4_2,
      - maximum number of layers is given by X, where
        - if the higher layer parameter maxMIMO-Layers of pdsch-ConfigMulticast is
        configured, X is given by that parameter;
        - otherwise, X equals to 1;
      - if the higher layer parameter mcs-Table given by a pdsch-ConfigMulticast for at least
      one common frequency resource (CFR) is set to ′qam256′, maximum modulation order
      Qₘ = 8 is assumed for DL-SCH; otherwise a maximum modulation order Qₘ = 6 is
      assumed for DL-SCH;
    - if the PDSCH is scheduled by DCI format 4_0,
      - maximum number of layers is 1;
      - if the higher layer parameter mcs-Table given by a pdsch-ConfigMCCH is set to
      ′qam256′, maximum modulation order Qₘ = 8 is assumed for DL-SCH; otherwise a
      maximum modulation order Qₘ = 6 is assumed for DL-SCH;
      - if the higher layer parameter mcs-Table given by a pdsch-ConfigMTCH is set to
      ′qam256′, maximum modulation order Qₘ = 8 is assumed for DL-SCH; otherwise a
      maximum modulation order Qₘ = 6 is assumed for DL-SCH;
    - n_{PRB} = n_{PRB,LBRM} is given by Table 5.4.2.1-1, where the value of n_{PRB.LBRM} for DL-SCH
    is determined according to the size of the CFR if only one CFR is configured to the UE;
    - maximum coding rate of 948/1024;
    $- {N}_{R E} = 156 \cdot {n}_{P R B} ;$
    - C is the number of code blocks of the transport block determined according to Clause 5.2.2.
  For one TB for UL-SCH, or for one TB for DL-SCH/PCH except for DL-SCH with
  PDSCH scheduled by DCI format 4_0/4_1/4_2,
    - maximum number of layers for one TB for UL-SCH is given by X, where
      - if the higher layer parameter maxMIMO-Layers of PUSCH-ServingCellConfig of the
      serving cell is configured, X is given by that parameter
      - elseif
        when the TranmissionScheme of pusch-Config is set to ‘SDMscheme’ or mDCI-STxMP
        and the higher layer parameters maxRank of pusch-Config of the serving cell are
        configured, the maximum rank L is the maximum value of 2*maxRank for the BWP,
        and X is given by the maximum value of the maximum rank L across all BWPs of the
        serving cell
        otherwise, the higher layer parameter maxRank of pusch-Config of the serving cell is
        configured, X is given by the maximum value of maxRank across all BWPs of the
        serving cell
      - otherwise, X is given by the maximum number of layers for PUSCH supported by the
      UE for the serving cell
    - maximum number of layers for one TB for DL-SCH/PCH is given by the minimum of X
    and 4, where
      if the higher layer parameter maxMIMO-Layers of PDSCH-ServingCellConfig of the
      serving cell is configured, X is given by that parameter
- otherwise, X is given by the maximum number of layers for PDSCH supported by
the UE for the serving cell
```

Based on the solution of the present disclosure, a mechanism about how to calculate LBRM when the UE supports STxMP transmission schemes is proposed.

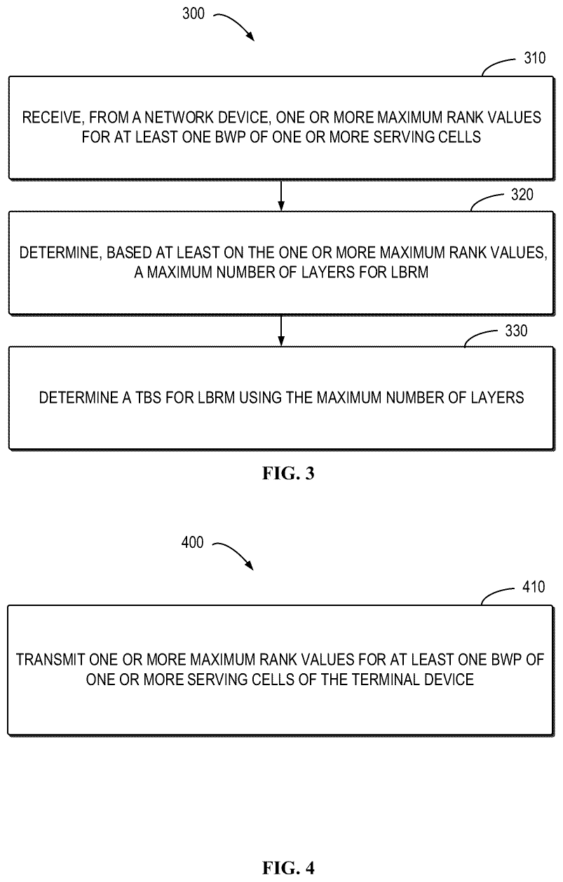

FIG. 3 shows a flowchart of an example method 300 of LBRM calculation for simultaneous multi-panel transmission according to some example embodiments of the present disclosure. The method 300 may be implemented at the terminal device 110 as shown in FIG. 1. For the purpose of discussion, the method 300 will be described with reference to FIG. 1.

At 310, the terminal device 110 receives, from a network device 120, one or more maximum rank values for at least one BWP of one or more serving cells of the terminal device. The one or more maximum rank values are associated with one or more PUSCH transmission schemes.

At 320, the terminal device 110 determines, based at least on the one or more maximum rank values, a maximum number of layers for LBRM.

At 330, the terminal device 110 determines a TBS for LBRM using the maximum number of layers.

In some example embodiments, the one or more PUSCH transmission schemes comprise at least one of: a single TRP PUSCH transmission, a S-DCI, based STxMP PUSCH transmission, or a M-DCI, based STxMP PUSCH transmission.

In some example embodiments, the single TRP PUSCH transmission comprises at least one of: a first mode of single TRP PUSCH transmission that is applicable when dynamic switching between single TRP transmission and S-DCI based STxMP PUSCH transmission is not configured, or a second mode of single TRP PUSCH transmission that is applicable when dynamic switching between single TRP transmission and S-DCI based STxMP PUSCH transmission is configured.

In some example embodiments, the terminal device 110 may determine the maximum number of layers for LBRM based at least on a maximum rank for the at least one BWP.

In some example embodiments, the one or more maximum rank values comprise at least one of the following: a first maximum rank value, a second maximum rank value, or a third maximum rank value.

In some example embodiments, the terminal device 110 may determine the maximum rank for the at least one BWP based on at least one of the following: at least one maximum rank value of the one or more maximum rank values, or at least one PUSCH transmission scheme of the one or more PUSCH transmission schemes.

In some example embodiments, the one or more maximum rank values comprise the first and the second maximum rank values, the terminal device 110 may determine the maximum rank for the at least one BWP as at least one of the following: a maximum value among the first maximum rank value and the second maximum rank value, or a sum of the first maximum rank value and the second maximum rank value, or a maximum value among the first maximum rank value and the second maximum rank value multiplied by 2.

In some example embodiments, the one or more maximum rank values comprise the first, the second and the third maximum rank values, the terminal device 110 may determine the maximum rank for the at least one BWP as at least one of the following: a maximum value among the first maximum rank value and a sum of the second maximum rank value and the third maximum rank value, or a maximum value among the second maximum rank value and a sum of the first maximum rank value and the third maximum rank value, or a maximum value among the first maximum rank value, the second maximum rank value and the third maximum rank value multiplied by 2, or a maximum value among the first maximum rank value, the second maximum rank value and the third maximum rank value.

In some example embodiments, the one or more maximum rank values comprise the first maximum rank value, the terminal device 110 may determine the maximum rank for the at least one BWP as the first maximum rank value multiplied by 2.

In some example embodiments, the one or more maximum rank values are comprised in a PUSCH configuration received from the network device.

FIG. 4 shows a flowchart of an example method 400 of LBRM calculation for simultaneous multi-panel transmission according to some example embodiments of the present disclosure. The method 400 may be implemented at the network device 120 as shown in FIG. 1. For the purpose of discussion, the method 400 will be described with reference to FIG. 1.

At 410, the network device 120 transmits, to a terminal device 110, one or more maximum rank values for at least one BWP of one or more serving cells of the terminal device. The one or more maximum rank values are associated with one or more PUSCH transmission schemes and to be used for the terminal device to determine a maximum number of layers for LBRM.

In some example embodiments, the one or more PUSCH transmission schemes comprise at least one of: a single TRP PUSCH transmission, a S-DCI, based STxMP PUSCH transmission, or a M-DCI, based STxMP PUSCH transmission.

In some example embodiments, the single TRP PUSCH transmission comprises at least one of: a first mode of single TRP PUSCH transmission that is applicable when dynamic switching between single TRP transmission and S-DCI based STxMP PUSCH transmission is not configured, or a second mode of single TRP PUSCH transmission that is applicable when dynamic switching between single TRP transmission and S-DCI based STxMP PUSCH transmission is configured.

In some example embodiments, the one or more maximum rank values are comprised in a PUSCH configuration received from the network device.

In some example embodiments, an apparatus comprises at least one processor; and at least one memory storing instructions that, when executed by the at least one processor, cause the apparatus at least to: receive, from a network device, one or more maximum rank values for at least one BWP of one or more serving cells of the apparatus, wherein the one or more maximum rank values are associated with one or more PUSCH transmission schemes; determine, based at least on the one or more maximum rank values, a maximum number of layers for LBRM and determine a TBS for LBRM using the maximum number of layers.

In some example embodiments, the one or more PUSCH transmission schemes comprise at least one of: a single TRP PUSCH transmission, a S-DCI, based STxMP PUSCH transmission, or a M-DCI, based STxMP PUSCH transmission.

In some example embodiments, the single TRP PUSCH transmission comprises at least one of: a first mode of single TRP PUSCH transmission that is applicable when dynamic switching between single TRP transmission and S-DCI based STxMP PUSCH transmission is not configured, or a second mode of single TRP PUSCH transmission that is applicable when dynamic switching between single TRP transmission and S-DCI based STxMP PUSCH transmission is configured.

In some example embodiments, the apparatus may be further caused to determine the maximum number of layers for LBRM based at least on a maximum rank for the at least one BWP.

In some example embodiments, the one or more maximum rank values comprise at least one of the following: a first maximum rank value, a second maximum rank value, or a third maximum rank value.

In some example embodiments, the apparatus may be further caused to determine the maximum rank for the at least one BWP based on at least one of the following: at least one maximum rank value of the one or more maximum rank values, or at least one PUSCH transmission scheme of the one or more PUSCH transmission schemes.

In some example embodiments, the one or more maximum rank values comprise the first and the second maximum rank values, the apparatus may be further caused to determine the maximum rank for the at least one BWP as at least one of the following: a maximum value among the first maximum rank value and the second maximum rank value, or a sum of the first maximum rank value and the second maximum rank value, or a maximum value among the first maximum rank value and the second maximum rank value multiplied by 2.

In some example embodiments, the one or more maximum rank values comprise the first, the second and the third maximum rank values, the apparatus may be further caused to determine the maximum rank for the at least one BWP as at least one of the following: a maximum value among the first maximum rank value and a sum of the second maximum rank value and the third maximum rank value, or a maximum value among the second maximum rank value and a sum of the first maximum rank value and the third maximum rank value, or a maximum value among the first maximum rank value, the second maximum rank value and the third maximum rank value multiplied by 2, or a maximum value among the first maximum rank value, the second maximum rank value and the third maximum rank value.

In some example embodiments, the one or more maximum rank values comprise the first maximum rank value, the apparatus may be further caused to determine the maximum rank for the at least one BWP as the first maximum rank value multiplied by 2.

In some example embodiments, the one or more maximum rank values are comprised in a PUSCH configuration received from the network device.

In some example embodiments, an apparatus comprises at least one processor; and at least one memory storing instructions that, when executed by the at least one processor, cause the apparatus at least to: transmit, to a terminal device, one or more maximum rank values for at least one BWP of one or more serving cells of the terminal device, wherein the one or more maximum rank values are associated with one or more PUSCH transmission schemes and to be used for the terminal device to determine a maximum number of layers for LBRM.

In some example embodiments, the one or more PUSCH transmission schemes comprise at least one of: a single TRP PUSCH transmission, a S-DCI, based STxMP PUSCH transmission, or a M-DCI, based STxMP PUSCH transmission.

In some example embodiments, the single TRP PUSCH transmission comprises at least one of: a first mode of single TRP PUSCH transmission that is applicable when dynamic switching between single TRP transmission and S-DCI based STxMP PUSCH transmission is not configured, or a second mode of single TRP PUSCH transmission that is applicable when dynamic switching between single TRP transmission and S-DCI based STxMP PUSCH transmission is configured.

In some example embodiments, the one or more maximum rank values are comprised in a PUSCH configuration received from the network device.

In some example embodiments, an apparatus capable of performing the method 300 (for example, implemented at the terminal device 110) may include means for performing the respective steps of the method 300. The means may be implemented in any suitable form. For example, the means may be implemented in a circuitry or software module.

In some example embodiments, the apparatus comprises means for receiving, from a network device, one or more maximum rank values for at least one BWP of one or more serving cells of the apparatus, wherein the one or more maximum rank values are associated with one or more PUSCH transmission schemes; means for determining, based at least on the one or more maximum rank values, a maximum number of layers for LBRM; and means for determining a TBS for LBRM using the maximum number of layers.

In some example embodiments, the one or more PUSCH transmission schemes comprise at least one of: a single TRP PUSCH transmission, a S-DCI, based STxMP PUSCH transmission, or a M-DCI, based STxMP PUSCH transmission.

In some example embodiments, the single TRP PUSCH transmission comprises at least one of: a first mode of single TRP PUSCH transmission that is applicable when dynamic switching between single TRP transmission and S-DCI-based STxMP PUSCH transmission is not configured, or a second mode of single TRP PUSCH transmission that is applicable when dynamic switching between single TRP transmission and S-DCI-based STxMP PUSCH transmission is configured.

In some example embodiments, the apparatus may further comprise means for determining the maximum number of layers for LBRM based at least on a maximum rank for the at least one BWP.

In some example embodiments, the one or more maximum rank values comprise at least one of the following: a first maximum rank value, a second maximum rank value, or a third maximum rank value.

In some example embodiments, the apparatus may further comprise means for determining the maximum rank for the at least one BWP based on at least one of the following:

at least one maximum rank value of the one or more maximum rank values, or at least one PUSCH transmission scheme of the one or more PUSCH transmission schemes.

In some example embodiments, the one or more maximum rank values comprise the first and the second maximum rank values, the apparatus may further comprise means for determining the maximum rank for the at least one BWP as at least one of the following: a maximum value among the first maximum rank value and the second maximum rank value, or a sum of the first maximum rank value and the second maximum rank value, or a maximum value among the first maximum rank value and the second maximum rank value multiplied by 2.

In some example embodiments, the one or more maximum rank values comprise the first, the second and the third maximum rank values, the apparatus may further comprise means for determining the maximum rank for the at least one BWP as at least one of the following: a maximum value among the first maximum rank value and a sum of the second maximum rank value and the third maximum rank value, or a maximum value among the second maximum rank value and a sum of the first maximum rank value and the third maximum rank value, or a maximum value among the first maximum rank value, the second maximum rank value and the third maximum rank value multiplied by 2, or a maximum value among the first maximum rank value, the second maximum rank value and the third maximum rank value.

In some example embodiments, the one or more maximum rank values comprise the first maximum rank value, the apparatus may further comprise means for determining the maximum rank for the at least one BWP as the first maximum rank value multiplied by 2.

In some example embodiments, the one or more maximum rank values are comprised in a PUSCH configuration received from the network device.

In some example embodiments, an apparatus capable of performing the method 400 (for example, implemented at the network device 120) may include means for performing the respective steps of the method 400. The means may be implemented in any suitable form. For example, the means may be implemented in a circuitry or software module.

In some example embodiments, the apparatus comprises means for transmitting, to a terminal device, one or more maximum rank values for at least one BWP of one or more serving cells of the terminal device, wherein the one or more maximum rank values are associated with one or more PUSCH transmission schemes and to be used for the terminal device to determine a maximum number of layers for LBRM.

In some example embodiments, the one or more PUSCH transmission schemes comprise at least one of: a single TRP PUSCH transmission, a S-DCI, based STxMP PUSCH transmission, or a M-DCI, based STxMP PUSCH transmission.

In some example embodiments, the single TRP PUSCH transmission comprises at least one of: a first mode of single TRP PUSCH transmission that is applicable when dynamic switching between single TRP transmission and S-DCI-based STxMP PUSCH transmission is not configured, or a second mode of single TRP PUSCH transmission that is applicable when dynamic switching between single TRP transmission and S-DCI-based STxMP PUSCH transmission is configured.

In some example embodiments, the one or more maximum rank values are comprised in a PUSCH configuration received from the network device.

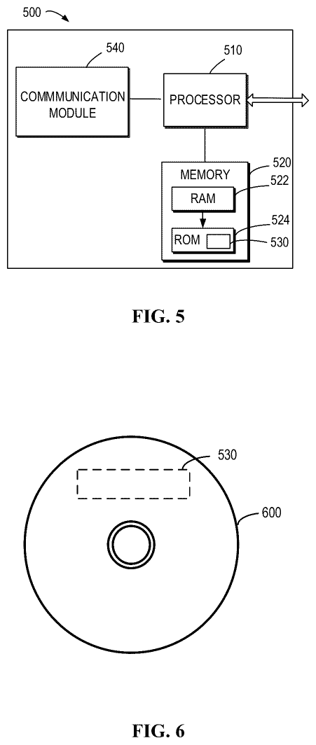

FIG. 5 is a simplified block diagram of a device 500 that is suitable for implementing example embodiments of the present disclosure. The device 500 may be provided to implement a communication device, for example, the terminal device 110 or the network device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 6 shows an example of the computer readable medium 600 which may be in form of CD, DVD or other optical storage disk. The computer readable medium 600 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. An apparatus, comprising:
at least one processor; and
at least one memory storing instructions that, when executed by the at least one processor, cause the apparatus at least to:
receive, from a network device, one or more maximum rank values for at least one bandwidth part, BWP, of one or more serving cells of the apparatus, wherein the one or more maximum rank values are associated with one or more physical uplink shared channel, PUSCH, transmission schemes;
determine, based at least on the one or more maximum rank values, a maximum number of layers for limited buffer rate matching, LBRM; and
determine a transport block size, TBS, for LBRM, using the maximum number of layers.

2. The apparatus of claim 1, wherein the one or more PUSCH transmission schemes comprise at least one of:
a single transmission reception point, TRP, PUSCH transmission,
a single-downlink control information, S-DCI, based simultaneous transmission from multiple panels, STxMP, PUSCH transmission, or
a multiple-downlink control information, M-DCI, based STxMP PUSCH transmission.

3. The apparatus of claim 2, wherein the single TRP PUSCH transmission comprises at least one of:
a first mode of single TRP PUSCH transmission that is applicable when dynamic switching between single TRP transmission and S-DCI based STxMP PUSCH transmission is not configured, or
a second mode of single TRP PUSCH transmission that is applicable when dynamic switching between single TRP transmission and S-DCI based STxMP PUSCH transmission is configured.

4. The apparatus of claim 1, wherein the apparatus is further caused to:
determine the maximum number of layers for LBRM based at least on a maximum rank for the at least one BWP.

5. The apparatus of claim 4, wherein the apparatus is further caused to:
determine the maximum rank for the at least one BWP based on at least one of the following:
at least one maximum rank value of the one or more maximum rank values, or
at least one PUSCH transmission scheme of the one or more PUSCH transmission schemes.

6. The apparatus of claim 5, wherein the one or more maximum rank values comprise at least one of the following:
a first maximum rank value,
a second maximum rank value, or
a third maximum rank value.

7. The apparatus of claim 6, wherein the one or more maximum rank values comprise the first and the second maximum rank values, and wherein the apparatus is further caused to:
determine the maximum rank for the at least one BWP as at least one of the following:
a maximum value among the first maximum rank value and the second maximum rank value, or
a sum of the first maximum rank value and the second maximum rank value, or
a maximum value among the first maximum rank value and the second maximum rank value multiplied by 2.

8. The apparatus of claim 6, wherein the one or more maximum rank values comprise the first, the second and the third maximum rank values, and wherein the apparatus is further caused to:
determine the maximum rank for the at least one BWP as at least one of the following:
a maximum value among the first maximum rank value and a sum of the second maximum rank value and the third maximum rank value, or
a maximum value among the second maximum rank value and a sum of the first maximum rank value and the third maximum rank value, or
a maximum value among the first maximum rank value, the second maximum rank value and the third maximum rank value multiplied by 2, or
a maximum value among the first maximum rank value, the second maximum rank value and the third maximum rank value.

9. The apparatus of claim 6, wherein the one or more maximum rank values comprise the first maximum rank value, and wherein the apparatus is further caused to:
determine the maximum rank for the at least one BWP as:
the first maximum rank value multiplied by 2.

10. The apparatus of claim 1, wherein the one or more maximum rank values are comprised in a PUSCH configuration received from the network device.

11. An apparatus, comprising:
at least one processor; and
at least one memory storing instructions that, when executed by the at least one processor, cause the apparatus at least to:
transmit, to a terminal device, one or more maximum rank values for at least one bandwidth part, BWP, of one or more serving cells of the terminal device, wherein the one or more maximum rank values are associated with one or more physical uplink shared channel, PUSCH, transmission schemes and to be used for the terminal device to determine a maximum number of layers for limited buffer rate matching, LBRM.

12. The apparatus of claim 11, wherein the one or more PUSCH transmission schemes comprise at least one of:
a single transmission reception point, TRP, PUSCH transmission,
a single-downlink control information, S-DCI, based simultaneous transmission from multiple panels, STxMP, PUSCH transmission, or
a multiple-downlink control information, M-DCI, based STxMP PUSCH transmission.

13. The apparatus of claim 12, wherein the single TRP PUSCH transmission comprises at least one of:
a first mode of single TRP PUSCH transmission that is applicable when dynamic switching between single TRP transmission and S-DCI based STxMP PUSCH transmission is not configured, or
a second mode of single TRP PUSCH transmission that is applicable when dynamic switching between single TRP transmission and S-DCI based STxMP PUSCH transmission is configured.

14. The apparatus of claim 11, wherein the one or more maximum rank values is comprised in a PUSCH configuration transmitted to the terminal device.

15. A method, comprising:
receiving, by a terminal device and from a network device, one or more maximum rank values for at least one bandwidth part, BWP, of one or more serving cells of the terminal device, wherein the one or more maximum rank values are associated with one or more physical uplink shared channel, PUSCH, transmission schemes;
determining, by the terminal device, based at least on the one or more maximum rank values, a maximum number of layers for limited buffer rate matching, LBRM; and
determining, by the terminal device, a transport block size, TBS, for LBRM, using the maximum number of layers.
